(19) United States
(12) Patent Application Publication
(10) Pub. No.: US 2005/0247917 A1
(43) Pub. Date: Nov. 10, 2005

(54) Infrared and heat absorption or reflection for raw materials and products

(76) Inventors: Dennis Dean Loyd, West Chester, OH (US); Larry Lee Lough, Springdale, OH (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/842,256

(22) Filed: May 10, 2004

(51) Int. Cl. C09K 11/06

(52) U.S. Cl. 252/582

(57) ABSTRACT

Techniques are provided for infrared and heat absorption or reflection. Glasseous materials having metal oxides are acquired or produced in a powder form, where residue of the materials within the powder has diameter sizes of 1 millimeter or less. The powder is integrated with raw materials of other products, and those products absorb or reflect electromagnetic wavelengths at or above 701 nanometers.

### FIELD OF THE INVENTION

The present invention is related to heat absorption, and more specifically to IR and heat absorbing additives used with raw materials and products.

### BACKGROUND OF THE INVENTION

The electromagnetic spectrum is a phrase used by scientist to refer to types of radiation. Radiation is energy that spears out as it travels. Visible electromagnetic radiation comes from natural (e.g., sun) or artificial sources (e.g., household lights) and comprises only a very small portion of the electromagnetic spectrum (wavelengths between 400 to 700 nanometers). Other types of radiation include radio waves, microwaves, infrared (IR), ultraviolet (UV), x-rays, and gamma-rays. Some radiation is harmful to human exposure at any level, such as x-rays and gamma-rays. Other radiation is harmful if excessive exposure occurs, such as UV, microwave, and IR. Generally, some radiation is for the most part safe at any level of exposure such as visible light and radio waves.

Energy is often expressed in terms of its frequency or wavelength. Each type of radiation energy in the electromagnetic spectrum occurs within a known frequency or wavelength range. Frequency and wavelength are units of measure for energy and can be converted between one another. In other words, a known frequency can be converted to a wavelength and vice versa.

Generally, radiation absorbers or reflectors have focused on harmful radiation within the wavelength range associated with microwaves, x-rays, and gamma-rays. Additionally, radiation absorbers or reflectors have focused on UV radiation occurring at or below the visible light wavelength range (less than or equal to 400 nanometers). There has been little to no developments in absorbing or reflecting radiation that occurs above 700 nanometers and is not associated with some of the more harmful radiation, such as x-rays and gamma-rays. That is, IR can occur at wavelengths above 700 nanometers and the ability to absorb or reflect this particular type of radiation at these wavelengths can provide some unique benefits to humans and products that they consume.

Therefore, there is a need for providing IR absorbing and reflecting capabilities at wavelengths that exceed 700 nanometers on the electromagnetic spectrum.

### SUMMARY OF THE INVENTION

Briefly and in general terms, glasseous materials are acquired in powder form or crushed into a powder form; residue associated with the glasseous materials within the powder can include hazardous or non hazardous metal oxides. If the metal oxides are hazardous, then the powder can optionally undergo a treatment procedure to remove surface metal oxides and prevent them from leaching from the powder. The powder can be mixed with raw materials of unfinished products or can be combined with other liquid substances and applied as a coating to finished products. The products having the powder exhibit properties that absorb or reflect electromagnetic wavelengths at or above 701 nanometers.

More specifically, and in one embodiment, a method of adding Infrared (IR) and heat absorbing or reflecting properties to a product are presented. Initially, glasseous materials having metal oxides are crushed into a powder. The crushed materials, which are included within the powder, have diameter sizes of 1 millimeter or less. Next, the powder is mixed with a product, and the resulting product exhibits properties associated with the metal oxides, which absorb or reflect electromagnetic wavelengths at or above 701 nanometers.

In still another embodiment, an IR and heat absorbing or reflecting product is described. The product includes a powder and raw materials. The powder is made of glasseous materials having metal oxides, and a residue of the glasseous materials, within the powder, has diameter sizes of one millimeter or less. The raw materials are associated with an unfinished product. The powder is integrated with the raw materials to form the product and to provide infrared and heat absorbing or reflecting properties at or above 701 nanometers of electromagnetic wavelengths for that product.

In yet another embodiment of the invention, an IR and heat absorption or reflection system is taught. The system includes glasseous materials and a metal oxide powder production system. The glasseous materials include metal oxides. The metal oxide powder production system grinds the glasseous materials into particles sizes of 1 millimeter or less forming a powder of the materials. The powder is operable to be integrated with raw materials of products, and the products absorb or reflect wavelengths of electromagnetic at or above 701 nanometers.

Still other aspects of the present invention will become apparent to those of ordinary skill in the art from the following description of various embodiments. As will be realized the invention is capable of other embodiments, all without departing from the present invention. Accordingly, the drawings and descriptions are illustrative in nature and not intended to be restrictive.

### BRIEF DESCRIPTION OF THE DRAWINGS

FIG. 1 is a flowchart of a method for adding Infrared (IR) and heat absorbing or reflecting properties in a product, according to an embodiment of the invention.

FIG. 2 is a diagram of an IR and heat absorbing or reflecting product, according to an embodiment of the invention.

FIG. 3 is a diagram of an IR and heat absorbing or reflecting system, according to an embodiment of the invention.

### DETAILED DESCRIPTION OF THE INVENTION

In the following description and the drawings illustrate specific embodiments of the invention sufficiently to enable those of ordinary skill in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

In various embodiments of the present invention, the phrase “glasseous material” is used. Glasseous material includes any combination of elements or materials of glass that also natively include metal oxides. Example metal oxides include silicon, aluminum, calcium, lead, tin, titanium, zinc, iron, cadmium, derivatives thereof, and other known metal oxides. Some metal oxides are unsafe for exposure; others are harmful at certain levels of exposure. In some cases, glasseous materials which include harmful metal oxides can be made safe for human exposure and the environment, if techniques are used to contain the metal oxides within the glasseous material and prevent then from leaching out of the glasseous material.

Metal oxides exhibit unique radiation absorbing or reflecting capabilities. That is, metal oxides (depending upon the types of metal oxides and the concentration levels) can absorb radiation or reflect radiation. Thus, some mixtures of metal oxides will reflect radiation and other mixtures will absorb radiation. For embodiments of this invention, the metal oxides absorb and reflect radiation at electromagnetic wavelengths at or above 701 nanometers.

Some example glasseous materials used with embodiments of this invention include consumer glass which is non-hazardous or glass (e.g., glass waste) integrated into other products that are hazardous because of the unsafe concentration levels of lead and other metal oxides (e.g., Cathode Ray Tube (CRT) monitors, etc.). The glasseous materials can be custom produced for purposes of the teachings of this invention or can be acquired as conventional glass waste.

With embodiments of the invention in which the glasseous materials include hazardous metal oxides, treatment techniques can optionally be deployed for purposes of making the glasseous materials safe for human exposure and disposal. One technique is to treat the glasseous material in an acid-water solution that removes surface metal oxides from the glasseous materials and thereby prevents the remaining metal oxides from leaching out of the native composition of the glasseous materials.

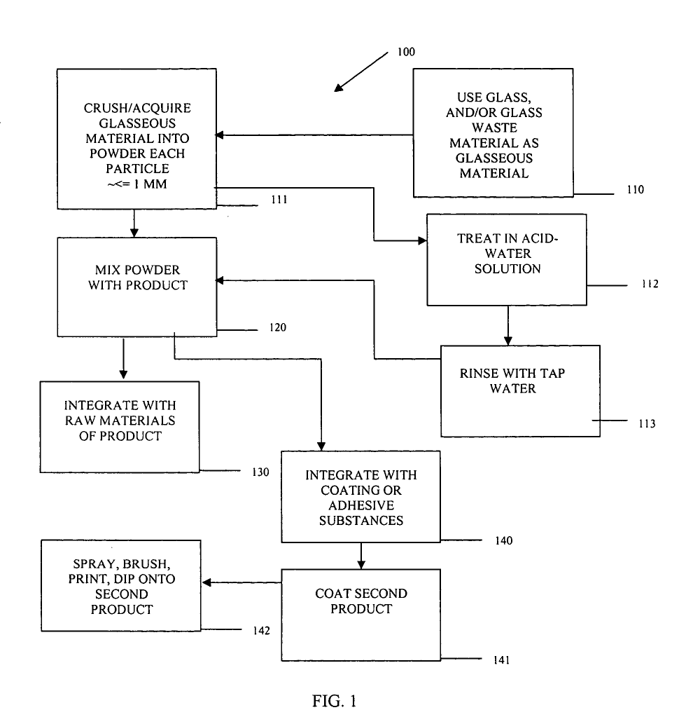

FIG. 1 illustrates a flowchart of one method 100 for adding Infrared (IR) and heat absorbing or reflecting properties in products. The method 100 is fabrication process, which reduces glasseous material to a powder substance. The fabrication process can be a standalone process that produces the powder or can be a conventional fabrication process for a product that integrates the production and use of the powder in the production of the product.

Initially, a glasseous material is acquired. That glasseous material can be custom produced for the fabrication process or can be acquired as waste from other products. Thus, the glasseous material can be any glass (e.g., glass, glass waste, etc.), as depicted at 110. Again, the glasseous materials include various concentrations of metal oxides.

At 110, the glasseous material is crushed into small particle sizes. These small glasseous material particles have diameter sizes of less than or equal to 1 millimeter. In some embodiments, the small particle sizes of the glasseous material are acquired from a separate process or production facility that produces the small particle sizes. At these small particle sizes, the glasseous material forms a residue that is a powder. The individual particles have relatively large surface areas and are extremely difficult to further fracture. Thus, the metal oxides that make up a portion of the composition of particles cannot practically be fractured by any naturally occurring force. This means that remaining metal oxides in the particles are safe for human exposure and environmental use, since they will not leach out of their native particle composition.

In some cases, some surface metal oxides may remain on the individually crushed particles of the glasseous material and it may be desirable to remove them in situations where they are deemed hazardous and toxicity is an issue. In these embodiments, the powder can be treated in an acid-water solution at 112 and then rinsed with tap water at 113 to remove the surface metal oxides from the surface of the particles that comprise the powder.

The powder's particles include in their native composition metal oxides. These metal oxides provide IR and heat absorbing or reflecting properties. The concentration and types of metal oxides can be configured based on the glasseous materials used in order to achieve IR absorption or IR reflection. The powder can then be mixed with a product at 120 in order to provide that product with IR and heat absorbing or reflective properties at or above 701 nanometers of an electromagnetic wavelength.

The powder can be mixed in a variety of manners. For example, at 130, the powder can be integrated into the native fabrication process of the product in order to provide that product with the novel IR absorption or reflection. By way of example only, consider a fabrication process that integrates the powder when producing a cell phone's outer shell, a roofing shingle, sheet metal, plastic, wood siding, etc. These resulting products will absorb or reflect IR and heat at wavelengths at or above 701 nanometers. Of course a variety of other native fabrication processes for the production of different products are possible. All such native fabrication processes that include the novel production and use of the powder are intended to fall within the scope of this invention.

Additionally, at 140, the powder can be integrated with other coating and adhesive substances, which are typically used to coat other or finished products. Some examples of these coating or adhesive substances include resins, paint, adhesives (e.g., glues, caulks, etc.), foams, inks, rubbers, plastics, metals, or common derivatives thereof. At 141, these composite coatings or adhesives can be used to cover or coat the surfaces of other second products. These coverings or coatings can be applied, at 142, by spraying, brushing, printing, or dipping the second product with or into the composite coatings or adhesives.

The novel produced powder acts as an additive to the native composition of raw materials used for a product and/or can be coated with other substances onto surfaces of a product. The result is a product that has novel properties that absorb or reflect IR and heat at electromagnetic wavelengths at or above 701 nanometers.

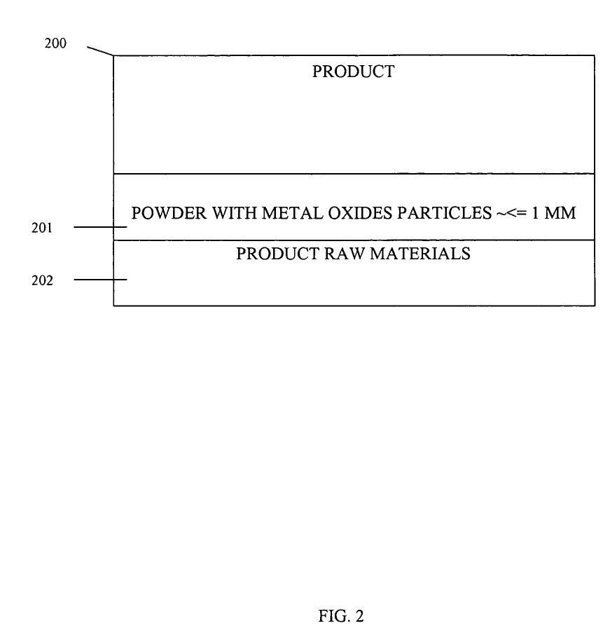

FIG. 2 is a diagram of one IR and heat absorbing or reflecting product 200. The product 200 can be produced with a process described above with respect to method 100 and FIG. 1. The product 200 can be anything produced for purposes of construction (e.g., wood, plastics, piping, siding, shingles, glass, etc.), for purpose of integration into another different product (e.g., fillers, resins, plastics, metals, adhesives, rubbers, inks, paints, or derivatives thereof), or for purposes of standalone products (e.g., consumer goods). The product 200 exhibits novel properties that absorb or reflect IR and heat at electromagnetic wavelengths at or above 701 nanometers.

The product 200 includes a novel powder 201 and its own raw materials 202. The novel powder 201 is made or acquired from glasseous material, such as glass or glass waste. Moreover, the powder 201 includes small particles of the glasseous material, such that each particle of the powder 201 has a diameter size of 1 millimeter or less. The powder 201 forms a solid residue of the glasseous materials at small particles sizes, such that the powder 201 can be integrated into the raw materials 202 that comprise the product 200.

Powder 201 integration into the raw materials 202 of the product 200 can occur in a variety of manners. For example, the powder 202 can be mixed with a liquid form of the raw materials 202. Additionally, the powder 202 can be aerosolized or liquefied and applied to the outer surface of the raw materials 202 when the raw materials 202 exist in a solid form.

Additionally, in some embodiments, the product 200 is actually used as a coating or adhesive which is coats or covers other additional products. In these embodiments, the product 200 can be sprayed, printed, or brushed onto the other products. Alternatively, the other products can be dipped in a bath of the product 200.

In some cases, the powder 201 is optionally treated to remove surface metal oxides from the surfaces of its composite particles. Treatment can occur by rinsing or dipping the powder 201 into an acid-water solution and then rinsing the powder 201 in tap water. The treatment ensures that any hazardous metal oxides are removed from the surfaces of particles within the powder 201.

By integrating the novel powder 201 into the raw materials 202 of a product 200, that product will absorb or reflect IR and heat at electromagnetic wavelengths at or above 701 nanometers. This creates novel products 200, which have conventionally not been available.

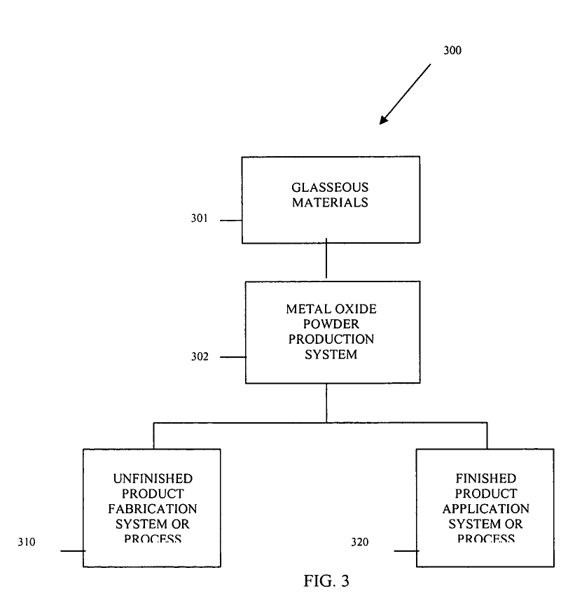

FIG. 3 is a diagram of one IR and heat absorbing or reflecting system 300. The IR and heat absorbing or reflecting system 300 can be a standalone system that produces the novel powder 201 discussed above with respect to FIG. 2 and method 100 of FIG. 1. Alternatively, IR and heat absorbing or reflecting system 300 can be integrated with or used to augment conventional fabrication processes and systems used to produce products (consumer or commercial based).

The IR and heat absorbing or reflecting system 300 includes glasseous materials 301 and a metal oxide powder production system 302. The glasseous material 301 is consumed by the metal oxide powder production system 302. The glasseous material 301 can include any glass or glass waste.

The metal oxide powder production system 302 grinds or crushes the glasseous material 301 into small particle sizes forming a residue or powder. The small particle sizes of the residue have diameter sizes of 1 millimeter or less. At these small diameter sizes, the native metal oxides of the particles cannot practically be fractured such that the metal oxides leach out of the individual particles. However, the small particle sizes still exhibit beneficial properties associated with metal oxides, namely that the particle sizes will absorb or reflect IR and heat for electromagnetic wavelengths at or above 701 nanometers.

In some embodiments, the metal oxide powder production system 302 also includes a treatment process or system that baths or rinses the powder in an acid-water solution in order to remove surface metal oxides from the small particles of glasseous materials that make up the residue or powder. That treatment process or system can also include a step that rinses the treated powder with tap water after application of the acid-water solution. This ensures that the powder is safe to be integrated with or applied to other products (finished or unfinished) without concern for safety or environmental disposal, if this is of import.

The resulting powder can then be packaged or integrated to augment finished or unfinished products. For example, the powder may be consumed in an unfinished product fabrication system or process 310. Alternatively, the powder may be used in a finished product application system or process 320. This means that the powder can be integrated into the raw materials of unfinished products or integrated into coating or adhesive substances and used to coat or cover surfaces of finished products.

The IR and heat absorbing or reflecting system 300 consumes glasseous materials 301 and uses its metal oxide powder production system 302 to produce a novel powder of the glasseous materials 301. That novel powder provides beneficial properties to finished or unfinished products by permitting those products to absorb or reflect IR and heat for electromagnetic radiation at or above 701 nanometers.

This means, by way of example only, that existing construction materials and consumer or commercial-based products can now provide improved and novel IR and heat absorbing or reflecting capabilities. This opens up the entire product producing industry to produce products with enhanced IR and heat properties. Moreover, in some instances, the glasseous materials can be acquired at virtually no expense or at very low expense, since in many cases the glasseous materials are associated with waste products that are being disposed of at landfills or recycling facilities. Further, integration of the powder is easily achieved and integrated into the products in unobtrusive and straightforward manners.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to one of ordinary skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A method for adding infrared and heat absorbing or reflecting properties to a product, comprising:
crushing glasseous materials having metal oxides into a powder, wherein residue of the crushed materials included within the powder have diameter sizes of 1 millimeter or less; and
mixing the powder with a product, wherein the product exhibits properties associated with the metal oxides which absorb or reflect electromagnetic wavelengths at or above 701 nanometers.

2. The method of claim 1, wherein crushing further comprises, crushing the glasseous materials, wherein the glasseous materials are at least one of glass and glass waste.

3. The method of claim 2 wherein crushing further comprises:
crushing the glass waste as the glasseous material into the powder;
treating the powder in an acid-water solution; and
rinsing the powder with tap water.

4. The method of claim 1, wherein mixing further comprises, integrating the powder into a fabrication process associated with raw materials of the product.

5. The method of claim 1, wherein mixing further comprises, incorporating the powder into the product which is at least one of a resin, plastic, foam, ink, paint, metal, rubber, adhesive, and derivative thereof.

6. The method of claim 5 further comprising, coating a second product with the product.

7. The method of claim 1, wherein coating further comprises, performing at least one of spraying, brushing, printing, and dipping the second product into or with a liquid form of the product.

8. An Infrared (IR) and heat absorbing or reflecting product, comprising:
a powder of glasseous materials having metal oxides, wherein residue of the glasseous materials within the powder have diameter sizes of one millimeter or less; and
raw materials associated with an unfinished product, wherein the powder is integrated with the raw materials to provide infrared and heat absorbing or reflecting properties at or above 701 nanometers of electromagnetic wavelengths for a product that includes the raw materials and the powder.

9. The product of claim 8, wherein the glasseous materials are at least one of glass and glass waste.

10. The product of claim 8, wherein the raw materials are at least one of resins, paints, plastics, foams, rubbers, metals, inks, and derivatives thereof.

11. The product of claim 8, wherein the product is a consumer-based product.

12. The product of claim 8, wherein the metal oxides include at least one of silicon, aluminum, calcium, lead, tin, titanium, zinc, iron, cadmium and derivatives thereof.

13. The product of claim 8, wherein the powder is treated to prevent the metal oxides from leaching out of the residue.

14. The product of claim 13, wherein the product is in a liquid form and is coated onto the outer surface of another product.

15. An Infrared (IR) and heat absorbing or reflecting system, comprising:
glasseous materials having metal oxides; and
a metal oxide powder production system that grinds the materials into particles sizes of 1 millimeter or less forming a powder of the materials, the powder operable to be integrated with raw materials of products, wherein the products absorb or reflect wavelengths of electromagnetic at or above 701 nanometers.

16. The IR and heat absorbing or reflecting system of claim 15, wherein the glasseous materials are at least one of glass waste and glass.

17. The IR and heat absorbing or reflecting system of claim 15 further comprising, a treatment system for removing surface oxides from surfaces of the particles preventing the surface oxides from leaching out of the particles.

18. The IR and heat absorbing or reflecting system of claim 15, wherein the powder is produced in an aerosol and sprayed onto a number of the products.

19. The IR and heat absorbing or reflecting system of claim 15, wherein the products are resins, plastics, metals, rubbers, inks, adhesives, foams, and derivatives thereof.

20. The IR and heat absorbing or reflecting system of claim 19, wherein the products are coated onto surfaces of additional products.
